(19) United States
(12) Patent Application Publication
(10) Pub. No.: US 2022/0307171 A1
(43) Pub. Date: Sep. 29, 2022

(54) METHOD FOR RECYCLING INSULATING WOOL, APPARATUS FOR PROCESSING INSULATING WOOL, FIBRE-REINFORCED FOAM, WOOD-BASED MATERIAL WITH COMBUSTION RESISTABILITY AND METHOD FOR PRODUCING A WOOD-BASED MATERIAL WITH COMBUSTION RESISTABILITY

(71) Applicant: BKRZ GMBH, Bogen (DE)

(72) Inventor: Rudolf FREUNDORFER, Bogen (DE)

(73) Assignee: BKRZ GMBH, Bogen (DE)

(21) Appl. No.: 17/635,810

(22) PCT Filed: Aug. 20, 2020
(86) PCT No.: PCT/EP2020/073277

§ 371 Date: Feb. 16, 2022

(30) Foreign Application Priority Data
Aug. 20, 2019 (DE) 10 2019 212 441.0

(51) Int. Cl. D04H 1/4209; D04H 1/4218; D04H 1/58; B02C 19/00

(52) U.S. Cl. CPC D04H 1/4209; D04H 1/4218; D04H 1/58; B02C 19/0056; B29K 2995/0015

(57) ABSTRACT

The present invention relates to a method for producing a recycled insulating material from insulating wool, said method comprising the steps of: comminuting insulating wool to give a first intermediate comprising fibre balls; adding binder to the first intermediate to give a second intermediate; hot-pressing the second intermediate into the desired shape, to give a third intermediate; and curing the third intermediate to give the recycled insulating material. The present invention further relates to a method for recycling insulating wool, an apparatus for processing insulating wool, and a fibre-reinforced foam. The invention additionally embraces a fire-resistant wood-based material and a method for producing it.

The invention relates to a method for producing a recycled insulating material from insulating wool, a method for recycling insulating wool, an apparatus for processing insulating wool, a fibre-reinforced foam, a fire-resistant wood-based material and a method for producing a fire-resistant wood-based material.

Insulating wool, such as mineral wool, which includes glass wool, rock wool, slag wool or “Ultimate” wool, is used to insulate roofs, beamed ceilings and doors, as these not only have very good insulating properties, but are also very light and resistant to moisture, mould and pest infestation. They are also a cheaper variant compared to an alternative insulation with polystyrene.

When a house is demolished, there is usually a large amount of insulating wool that must be disposed of. This is done according to traditional methods in special containers to prevent the fibres contained in them from coming into contact with the skin or being inhaled. These containers are then taken to suitable landfill sites for final disposal. This is a relatively complex disposal process, which represents a major environmental impact. There are currently no more environmentally friendly alternatives available, especially since conventional recycling processes, such as incineration, are unsuitable for the non-combustible insulating materials.

It is therefore the object of the invention to provide methods, apparatus and materials with which environmentally friendly recycling of insulating wool is made possible and/or environmentally friendly insulating materials can be produced.

According to the invention, this object is achieved according to a first aspect by a method for producing a recycled insulating material from insulating wool, which comprises the steps of:
S1: comminuting insulating wool to give a first intermediate comprising fibre balls,
S2: adding binder to the first intermediate to give a second intermediate,
S3: hot-pressing the second intermediate into the desired shape to obtain a third intermediate, and
S4: curing the third intermediate to obtain the recycled insulating material.

The recycled insulating material produced in this way can be used as a new insulating material and prevents the insulating wool used in the process from being disposed of in a landfill site and thus causing high disposal costs and a high level of environmental pollution. In addition, the recycled insulating material can be used again, like the insulating wool to be recycled, for insulating roofs, beamed ceilings and doors, for example.

When insulating wool is comminuted, as addressed in step S1, the insulating wool can be comminuted into three different fractions. A first fraction, preferably 5% to 25% of the total, may comprise dust and particles. The dust and particles are so small that they can be added to the raw melt during the production of new insulating wool in a conventional process in which, among other things, fine-grained sand is used as the starting material. A second fraction, preferably 30% to 45% of the total, may comprise individual fibres and fibre bundles. Their size is also small enough to be added to a conventional insulating wool manufacturing process. A third fraction, preferably 35% to 60% of the total amount, may comprise fibre balls, the diameter of which is preferably between 0.1 mm and 1 cm. These fibre balls are included in the first intermediate which is used in the method according to the invention for producing a recycled insulating material.

The fibre balls can, for example, be heaped up to form a fibre body, to which the binder is added in step S2. The fibre body can already be formed into the desired shape and the binder can be sprayed onto the fibre body to obtain the second intermediate. Alternatively, it is possible to mix the first intermediate and the binder together and to bring the second intermediate thus obtained into a desired shape. A desired shape can be, for example, a panel shape, a sheet shape, a tube shape, or any curved shape. By means of both alternatives, the second intermediate can be a fibre pulp which can be formed into a shape. Generally speaking, various options can be used, such as mixing, stirring, wetting or impregnating. A fibre pulp, a wetted fibre body or a fibre composite can be produced as the second intermediate. The wetting can vary within the fibre pulp, the fibre body or the fibre composite. A fibre fleece may also be mentioned as the second intermediate.

The second intermediate can be formed as a relatively dry fibre composite, with binders that preferably fuse at low temperatures, for example 60° C. to 150° C. A moistened, possibly wet, second intermediate can also be added by the addition of water in step S2 for better formability of the second intermediate, for example by pouring, flaking, stirring or mixing. The added water can be removed again by evaporation at temperatures of 100° C. to 180° C. For example, measures described later, such as the use of structural elements such as a skeleton structure or open cores, can be used to support this.

The binder can be organic or inorganic or a mixture of both. For example, water glass, in particular low-sodium water glass, can be used as an inorganic binder. However, renewable raw materials such as starch, for example corn, potato and vegetable starch, lignin and sugar, or other organic substances such as resins, for example melamine, urea resin or phenolic resin, can be used as binders. Such organic binders are preferably used which, in a subsequent pyrolysis treatment, such as, for example, a high-temperature process, ensure the highest possible yield of pyrolysis carbon.

Depending on the specific application, it is advantageous if the insulating wool to be comminuted is rock wool and the binder is inorganic, in particular comprising water glass, or the insulating wool to be comminuted is glass wool and the binder is organic, in particular one or more of powder, urea, resins, starch, lignin and sugars. In this way, materials with similar melting points can be combined with one another, which enables or simplifies further processing of the recycled insulating material.

Furthermore, further additives which influence the properties of the recycled insulating material to be produced can be added in step S2. A foaming agent can be added as a possible additive in step S2, so that the second intermediate includes the foaming agent in addition to the first intermediate and the binder. The term “foaming agent” can be used synonymously with a catalyst or a blowing agent and can be, for example, baking powder or sugar. However, renewable raw materials such as vegetable starches, sugar, lignin and biological catalysts are also conceivable. The foaming agent can cause cavities to form in the recycled insulating material, thereby reducing the density of the recycled insulating material and thus making the recycled insulating material lighter.

An inorganic foaming agent such as aluminium powder can also be used. All of the aforementioned foaming agents, which are preferably suitable for forming cavities in the recycled insulating material, can also be regarded as insulation-supporting additives, since the cavities ensure a good insulating effect.

Another additive that can be added in step S2 is a semi-finished material, such as foam glass granulate, which further optimises the properties of the recycled insulating material. For example, when rock wool is used as insulating wool and an inorganic binder to achieve better material properties, such as better sound or heat insulation, increased fire resistance and better strength, it is also possible to add prefabricated, semi-finished materials, such as foam glass granulate in different grain sizes, in step S2.

Another additive that can be added in step S2 is latex, for example in liquid form. This can increase the resistance of finished recycled insulating materials to moisture and water.

Another additive that can be added in step S2 is slaked quicklime, such as slaked lime or lime putty, which can be used in conjunction with an inorganic binder.

Other particularly inexpensive additives that can be added in step S2 are, for example, organic residues such as straw or sawdust, or inorganic or mineral fillers, e.g. clay, rock dust, pumice or calcium silicate.

Preferably, an organic foaming agent is used when glass wool is comminuted as insulating wool in step S1, and an inorganic foaming agent is used when rock wool is comminuted as insulating wool in step S1. This has the advantage that these material combinations react particularly well with one another.

The recycled insulating material can have improved fire resistance if non-combustible rock wool is used as insulating wool and only inorganic binders are used, i.e. the addition of organic binders or other organic additives is avoided. In general, the fire protection properties of the recycled insulating material can be improved if combustible organic materials are dispensed with.

Other additives that can be added in step S2 are wood chips, natural fibres and/or synthetic fibres, which are particularly distinguished by their excellent ecological balance. In such a case, in addition to the first intermediate and the binder, the second intermediate would also include wood chips, natural fibres and/or synthetic fibres and possibly the foaming agent. The addition of woodchips can increase the compressive strength of the recycled insulating material and can improve the sound insulation thereof.

For example, wood chips impregnated with water glass can increase the fire resistance of the recycled insulating material. These woodchips impregnated with water glass are preferably used if rock wool is comminuted as insulating wool in step S1. Wood chips from renewable raw materials are particularly preferable as a possible raw material for wood chips, since they are easy to process, are easy to recycle and enable the aforementioned advantages. Renewable raw materials for use as wood chips are, for example, poplar, birch and willow, of which damaged wood and windblown wood can also be used.

It goes without saying that with wood chips, natural fibres and/or synthetic fibres as additives with a suitable choice of binders, high-quality, completely prefabricated recycled insulating material wall laminates for system constructions can be produced that meet the highest fire protection requirements.

A fire-resistant wood-based material, which is described below and is regarded as capable of independent protection, can also be added in step S2. The fire-resistant wood-based material comprises a wood strip which, for example, has a thickness of 1 mm to 10 mm, a width of 1 mm to 50 mm and a length of 500 mm to 4000 mm and is preferably pricked, comprises insulating wool fibres and comprises a binder which preferably penetrates into the wood strips by means of the pricked configuration and with which the wood strips are impregnated, wherein the binder is selected from one or more of inorganic water glass, inorganic water glass specifications, organic resins such as urea, melamine or phenol, fire-retardant additives such as precipitants or acid or acid hardener. This increases the stability of the recycled insulating material. The wood strips can be laid in a composite to create high bending strength. The wood strips can be arranged in planes that are substantially parallel to one another in order to obtain a material with good flexural strength. The wood strips can particularly preferably run crosswise or diagonally to one another within these planes, so that the flexural strength is increased even further. The insulating wool fibres of the wood-based material can be obtained by comminuting insulating wool, for example when recycling insulating wool according to the invention.

Another additive that can be added in step S2 includes fire retardants. If fire resistance is to be improved specifically when glass and mineral wool are used as insulating wool, conventional flame inhibitors and flame retardants, for example those also used in the field of plastics insulation, can be added as additives in step S2. Furthermore, precipitants such as acids or acid hardeners can be added.

Possible additives can protect the resulting recycled insulating material against pests during later use, so that it can be used advantageously in areas close to the ground. However, a growth basis for pests can also be ruled out from the outset. All organic components in the insulating wool, in the binder or in other additives that enable pest growth can be converted by a final high-temperature treatment, such as the pyrolysis treatment described later, into gas and can be driven out of the recycled insulating wool.

Furthermore, the fibre balls comprised in the first intermediate or the recycled insulating material can already be impregnated against moisture. The use of mineral impregnations, such as Geniseptoy, is recommended here in order to ensure permanent moisture-proofing. Coating with and/or drying out of water glass or modified water glass can also result in permanent moisture-proofing if this is done in the fibre balls or the recycled insulating wool.

Preferably, the second intermediate is in the form of a fibre pulp. It is also possible here to add water in step S2 if the second intermediate is too dry or is not in the form of a desired fibre pulp. In order to improve the adhesion of additives to the first intermediate, it can also be wetted with water. This is particularly recommended for powdered additives.

The second intermediate comprising the binder and possibly one or more additives is hot-pressed into the desired shape in step S3. Hot-pressing is used to produce a third intermediate, in which the binder and optionally one or more additives can be incorporated into the first intermediate. A third intermediate, which can also be designated as, for example, a fibre body or fibre moulded body, the density of which depends mainly on the pressure applied during hot-pressing, is preferably produced after the hot-pressing.

The parameters to be selected for hot-pressing, such as temperature, pressure and time, depend on the binder selected in each case and should be selected in such a way that the binder reacts and bonds with the fibre balls of the first intermediate. The parameters of temperature, pressure and time are preferably chosen in such a way that large pores remain in the third intermediate. In step S3, the second intermediate is preferably hot-pressed at a temperature of 50° C. to 180° C. and a pressure of 0.05 bar to 5 bar, or 0.05 kg/cm² to 5 kg/cm². A preferred residence time can be between 5 minutes and 240 minutes. It goes without saying that the third intermediate can have a different density, depending on the parameters selected during hot-pressing, with a higher pressure leading to a higher density. Furthermore, the parameters mentioned can vary within the specified ranges depending on the type of insulating wool used, the added binder and, if applicable, one or more added additives.

If rock wool is used as insulating wool in step S1, suitable parameters for the hot-pressing in step S3 can be a pressure of 0.1 bar to 5 bar, or 0.1 kg/cm² to 5 kg/cm², a temperature from 80° C. to 180° C. and a residence time from 20 min to 240 min.

If glass wool is used as insulating wool in step S1, suitable parameters for the hot-pressing in step S3 can be a pressure of 0.05 bar to 2 bar, or 0.05 kg/cm² to 2 kg/cm², a temperature from 50° C. to 160° C. and a residence time from 5 min to 150 min.

In general, the recycled insulating material can be hot-pressed with low pressure and preferably high temperatures in step S3, whereby the water resistance is increased. Panels for external use can be hardened with higher pressure, since a dense material is usually required for external use. Materials with higher densities have a lower water retention behaviour, which increases weather resistance. In one embodiment, a wood-based material of the type according to the invention described above can be pressed with such a pressure during hot-pressing that the resulting material has a density of more than 1 kg/cm³.

During hot-pressing, gases or vapours can arise which can preferably escape again from the third intermediate that is being produced or has already been produced. In order to simplify the escape of gas or vapour, structural elements such as channels, wires, grooves, cores, bores and/or lattice structures can be provided, which can be arranged within the second intermediate and can optionally be removed after hot-pressing. The structural elements can be made of wood or wood-based materials.

For the production of monolithic and very thick insulating material structures, for example with a thickness of more than 20 cm, it can be advantageous to insert structural elements into the mass to be pressed during production in order to allow the escape of water vapour or reaction gases produced during hot-pressing. Such structural elements can be formed from the same recycled insulating material that has already been manufactured and cured in a previous step and can have, for example, channels, grooves, bores or lattice structures. A further advantage of such channels is an improved introduction of heat into the second intermediate to be pressed, since the hot air can penetrate directly into the interior of the material via the channels.

Alternatively, the structural elements could be formed from a different material, for example a material with a higher load-bearing capacity, so that the resulting recycled insulating material is statically reinforced and can therefore withstand higher loads. Such materials can be used for example for a wall or for wall cores for masonry. Examples of such a material are Kerto wood or glued wood. Preferably, however, the aforementioned fire-resistant wood-based material according to the invention is used. This comprises wood strips, which for example have a thickness of 1 mm to 10 mm, a width of 1 mm to 50 mm and a length of 500 mm to 4000 mm and are possibly pricked, insulating wool fibres and a binder, which has penetrated the wood strips and with which the wood strips are impregnated, wherein the binder is selected from one or more of inorganic water glass, inorganic water glass specifications, organic resins such as urea, melamine or phenol and fire-retardant additives such as precipitants or acid or acid hardeners. Such a fire-resistant wood-based material can be assigned to fire resistance class B1 (according to EN 13501-1 and DIN 4102-1). The pricking that may be present can improve the penetration of the binding agent into the wooden strips.

A method according to the invention for producing a fire-resistant wood-based material, for example as described above, comprises the step of providing a wood strip, for example with a thickness of 1 mm to 10 mm, a width of 1 mm to 50 mm and a length of 500 mm to 4000 mm, optionally pricking the wood strip and impregnating the wood strip with liquid binder which is selected from one or more of inorganic water glass, inorganic water glass specifications, organic resins such as urea, melamine or phenol, and fire-retardant additives such as precipitants or acid or acid hardeners, and adding insulating wool fibres. For example, a pricking tool such as a pricking roller can be used for pricking. The pricking can be provided at least every 3 mm. The insulating wool fibres are preferably mixed with the binder to form a pulp and then the wood strips are wetted with this pulp, for example it is poured over them.

It is also possible for several of these wood strips, which may be pricked and impregnated, to be pressed or/and glued together to form a profile. In this way, the profile can also be assigned to fire resistance class B1 (according to EN 13501-1 and DIN 4102-1). Similar to the known OSB process, the wood strips can be glued and pressed under high pressure to form a new type of wood-based material with a fire resistance class of at least B1 or higher. The process can be precisely controlled and clocked using pressure and temperature sensors.

The method for producing a wood-based material can therefore further comprise providing a plurality of impregnated wood strips which have been produced as described above, optionally applying adhesive to the plurality of wood strips and pressing the plurality of wood strips together.

The wood strips can be made of spruce wood, preferably spruce wood damaged by bark beetles, or/and poplar-like wood. The use of fast-growing poplar-like wood is particularly suitable here. However, also birch and willow from which damaged wood and windblown wood can also be used, are conceivable as raw material for the wood strips. When choosing, attention can be paid to the sustainability of the raw materials.

The third intermediate obtained after hot-pressing is then cured in step S4. In the simplest case, the hardening comprises cooling of the third intermediate to form the recycled insulating material, which preferably results in a dense body. The recycled insulating material obtained after cooling can already be used as insulating material, for example as weather-resistant panel material for external use. Applications for finished system components for building construction are also conceivable.

Weather-resistant panels made of recycled insulating material for external use and an A2 (according to EN 13501-1 and DIN 4102-1) fire-resistant recycled insulating material can be produced after cooling in step S4 when using rock wool as insulating wool and inorganic binders. These can be for external use in the form of boards made of recycled insulating material, for example if foam glass granulate was added as an additive in step S2.

The recycled insulating wool obtained in this way, i.e. by cooling in step S4, which can also be referred to as a fibre body, can have sufficient strength for direct use as an insulating material. Furthermore, this recycled insulating wool can have sufficient dimensional stability and warpage resistance for further processing. It can also be robust enough to be handled in a production process that includes operations such as stacking, interim storage, loading and unloading.

However, step S4 of curing can also include further treatment steps of the third intermediate in addition to cooling or as an alternative to cooling. The curing in step S4 preferably includes a pyrolysis treatment of the third intermediate to form the recycled insulating material. In the following, recycled insulating materials that have undergone pyrolysis treatment are referred to as refined recycled insulating materials. The pyrolysis treatment can be carried out directly after the hot-pressing step or after the third intermediate has been cooled.

A pyrolysis treatment is understood to mean a heat treatment, coking, an annealing process and/or a sintering process.

The pyrolysis treatment can lead to the refined recycled insulating material, which has improved fire resistance compared to non-refined recycled insulating material. For example, if the recycled insulating material is pyrolysed, for example coked, a very high-quality mineral fibre-based insulating foam can be obtained, which can be used particularly advantageously in an area close to the ground.

It goes without saying that the carbon required for refining can already be contained in the recycled insulating material. This can be contained in the binder or added as an additive, for example as a carbon-containing additive, in step S2. Additives containing carbon can be renewable resources, such as starch, for example corn, potato and vegetable starch, sugar and lignin. During the pyrolysis treatment, these can help to create an open-cell or closed-cell foam structure.

In one possible method, the pyrolysis treatment is carried out with the exclusion of oxygen at temperatures between 400° C. and 1450° C. and the residence time is preferably 3 minutes to several hours, for example up to about 25 minutes to 2 hours. The temperature and/or the residence time is preferably selected in such a way that a closed-cell carbon foam is formed during the pyrolysis treatment, for example the coking. In the case of insulating wool that is to be recycled and is harmful to health, the temperatures can be specified in such a way that the harmful substances contained therein decompose or pass into the gas phase. The resulting gases can be collected and fed back into the process as an energy supplier. This is an advantage, for example, if type 3 insulating wool is used, which does not have the RAL quality mark.

In the case of glass wool as insulating wool in step S1 or if the recycled insulating wool is only to be used for thermal insulation, the pyrolysis treatment, for example a thermal post-treatment, takes place at lower temperatures and shorter throughput times. To use the recycled insulating material as fire-resistant insulation, rock wool can be used as insulating wool in step 1, and the residence time and the temperature are increased.

The pyrolysis treatment, for example the tempering process, can also have a residence time of several hours, including heating and cooling phases, in order to obtain particularly high-quality new building materials. A precisely controlled cooling phase in particular ensures warpage resistance and freedom from cracks.

Alternatively or additionally, short mineral fibres which are harmful to health and can still be contained in the insulating wool to be recycled, can be firmly incorporated in the recycled insulating material by means of additives with a carbon content, which can be contained, for example, in the binder or can be added as a carbon-containing additive. In this way, a harmful effect can be avoided.

For example, when the pyrolysis treatment is a sintering process, an element contained in rock wool, such as silicon, can react with the carbon-containing binder or a carbon-containing additive, resulting in the formation of silicon carbide. A possible sintering process can take place at temperatures between 1200° C. and 1450° C. In this way, a very high quality mineral foam can be formed. This can, for example, meet or even exceed the requirements placed on insulating materials such as foam glass (shaped glass).

The aforementioned temperature ranges for the pyrolysis treatment are suitable for inducing a fusion of carbon with the fibres of the fibre balls and form a fibre-reinforced, refined recycled insulating material.

A foaming agent was preferably added as an additive in step S2, resulting in a fibre-reinforced carbon foam. This takes place, for example, by the foaming agent creating gas bubbles in which, for example, hydrogen gas is present, which diffuses out within a short time, resulting in a closed-cell, fibre-reinforced carbon foam. The advantages mentioned above in relation to the foaming agents result, namely a recycled insulating material which is relatively light due to its low density and has good insulating properties.

In a further aspect of the invention, the above object is achieved by a method for recycling insulating wool.

The method according to the invention comprises a method according to the first aspect of the invention. This method for recycling insulating wool makes it possible to recycle another fraction of shredded insulating wool, namely the fraction containing single fibres and small fibre bundles, by adding the individual fibres and small fibre bundles to a conventional method for manufacturing insulating wool. The disposal costs and the environmental impact of insulating wool to be disposed of are thus reduced.

According to a third aspect of the invention, the object mentioned above is achieved by the apparatus according to the invention for processing insulating wool.

The apparatus according to the invention for processing insulating wool comprises a drum, a tool group which is arranged on a lower region of the drum, a drive which drives the drum and the tool group to rotate relative to one another, a housing enclosing the drum, a suction device and an actuating element.

It is characterised in that at least one outer wall of the drum has an opening, so that an intermediate space between an outer face of the drum and an inner face of the housing is connected to an interior of the drum via the opening, wherein a position of the actuating element determines how much material can pass through the opening, and wherein the suction device is set up to draw off material located in the intermediate space.

The apparatus according to the invention makes it possible to comminute insulating wool to be recycled, so that it can be further processed into recycled insulating material and/or fed to a conventional method for producing insulating wool. It therefore contributes to the fact that less insulating wool has to be disposed of at landfill sites, which reduces the disposal costs of insulating wool and the environmental impact due to landfilled insulating wool.

For example, the apparatus according to the invention can be used in the method for producing a recycled insulating material according to the first aspect of the invention in step S1, in order to comminute insulating wool to be recycled. The apparatus can be suitable for comminuting the insulating wool into the three different fractions mentioned in the introduction, i.e. the first fraction with preferably 5% to 25% of the total amount which can comprise dust and particles, the second fraction with preferably 30% to 45% of the total amount which can comprise individual fibres and fibre bundles, and the third fraction with preferably 35% to 60% of the total amount which can comprise fibre balls.

The apparatus according to the invention is preferably set up to process insulating wool in such a way that different fractions, for example the three fractions mentioned above, can be removed. In order to comminute the insulating wool, the apparatus comprises the tool group, which comprises at least one tool. The tool group can be, for example, a working shaft or disc equipped with tools. The tool group can preferably engage in an interior space of the drum or can protrude into it.

In one possible configuration, the tool group comprises at least one tool selected from a rake, a rod, a cutting tool, a friction body, a trapezoid, a comb, a beater, in particular a spherical beater, or a combination thereof. All these tools are suitable for comminuting the insulating wool and breaking it down into several fractions, such as the three fractions mentioned above. The fibres can be abraded with the tools mentioned. Blunted tools are advantageously used here, for example in the form of a rod, a trapezoid or a beater.

For example, blunt knife-like cutting tools are very suitable, since the insulating wool fed into the drum is not excessively comminuted in an undesirable manner, in contrast to the use of sharp cutting edges. This means that less dust and particles can be produced and the proportion of material fractions that can be used for new recycled insulating wool can be increased. The beaters included in the tool group are better able to break up material residues in the drum and bring them into the material flow.

Due to the arrangement of the tool group at a lower region of the drum, material in the drum, such as insulating wool or insulating wool that has already been comminuted, falls in the form of fibres, balls, bundles, etc. in the direction of the tool group due to gravity. In addition, a material flow generated in the drum, for example from insulating wool or insulating wool that has already been comminuted, can be such that the tool group can grasp the material. The relative movement between the drum and the tool group generated by the drive is preferably such that a central, in particular elliptical material flow is produced in the drum. A drum in the form of a cylinder may suitably be used to achieve the desired material flow.

In a further development of the invention, the apparatus can also include an inner drum wall tool group which is arranged on or adjacent to an inner drum wall of the drum. In this way, the separation of the insulating wool to be recycled into a number of fractions, for example the three fractions mentioned above, can take place more efficiently. The tool group arranged on the drum wall preferably comprises one or more tools selected from a rake, a rod, a comb, a cutting tool, a friction body, a trapezoid and a beater, preferably a spherical beater.

In principle, it is conceivable that the opening is arranged on a lateral surface of the drum, on the outer face or inner face of which the actuating element is arranged such that the opening area of the opening through which material can pass is determined by means of the positioning of the actuating element. Material such as insulating wool or insulating wool that has already been comminuted, which is of a suitable size to pass through the opening, can thus leave the interior of the drum and can be removed from the intermediate space by the suction device. In this way it is possible to avoid stopping the apparatus to remove the material from the drum.

Particularly advantageously, the actuating element can be changed during operation of the apparatus, i.e. when there is a relative movement between the tool group and the drum, so that different fractions can be removed from the drum one after the other. It is also possible to collect the fibre balls specifically on segments arranged in the drum and to remove them when the apparatus is at a standstill. It is also possible for suspended matter, such as small particles and dust, to be drawn off directly from the drum against the direction of gravity, for example by means of the suction device.

It goes without saying that in order to achieve a material flow, for example a central, in particular elliptical material flow, a central area of the drum is empty, i.e. no segment and no tool group is arranged in this area.

According to a fourth aspect of the invention, a fibre-reinforced foam is provided which can be used as an insulating material. The fibre-reinforced foam according to the present invention comprises a foam and fibres which are embedded in the foam.

The fibre-reinforced foam according to the invention can be produced, for example, by means of the method as described in the first aspect of the invention. It can be used as an insulating material and is characterised by its very low dead weight and its high static load-bearing capacity.

The fibre-reinforced foam can result from the accumulation of pyrolysis carbon during the pyrolysis treatment, for example a high-temperature process, on the fibre balls. Generally speaking, all additives, additional substances, fillers and extenders will be converted to pyrolysis carbon. Preferably, the partially produced carbon or the pyrolysis carbon from the additives and from the binder is coated or fused with the contained fibre structure. A foam with fibre-reinforced cell walls can be produced. Organic binders or additives such as starch foam up during the process due to their popcorn effect. Accordingly, these can be deposited on the fibres or fibre balls with cavities.

If starch is added as an additive in step S2, it can foam up during the pyrolysis treatment, wherein water splits off and water vapour is produced before elemental carbon is formed. By means of the aforementioned popcorn effect, further blowing agents can be dispensed with when using starch. Natural or modified starch can be used in solid or dissolved form.

Pressed recycled insulation panels produced after hot-pressing can be provided with a glass fibre fabric or aluminium foil on one or both sides before the pyrolysis treatment if the pyrolysis treatment is carried out at temperatures below the melting temperature of the glass fibre fabric or aluminium foil.

By means of an addition of electrically conductive carbon fibres or metal fibres in step S2, the recycled insulating material can shield against electromagnetic waves, also known as electrosmog.

For example, due to its aromatic structure, lignin produces a particularly high proportion of pyrolysis carbon, which can easily accumulate on the fibres or fibre balls and can fuse with them to form a material. Sugar and lignin, for example, melt before the pyrolysis treatment and encapsulate the fibres of the fibre balls, resulting in better strength in the end product.

For protection against moisture, the pyrolysis carbon can be charged with water glass, for example modified water glass.

In a further embodiment of the invention, the recycled insulating material refined by pyrolysis treatment can be provided with a powder coating/stove-enamel finish or ceramic enamelling, which improves the weather resistance and/or the visual appearance of the material.

The invention will be explained in more detail below on the basis of an embodiment with reference to the accompanying drawings. In the drawings:

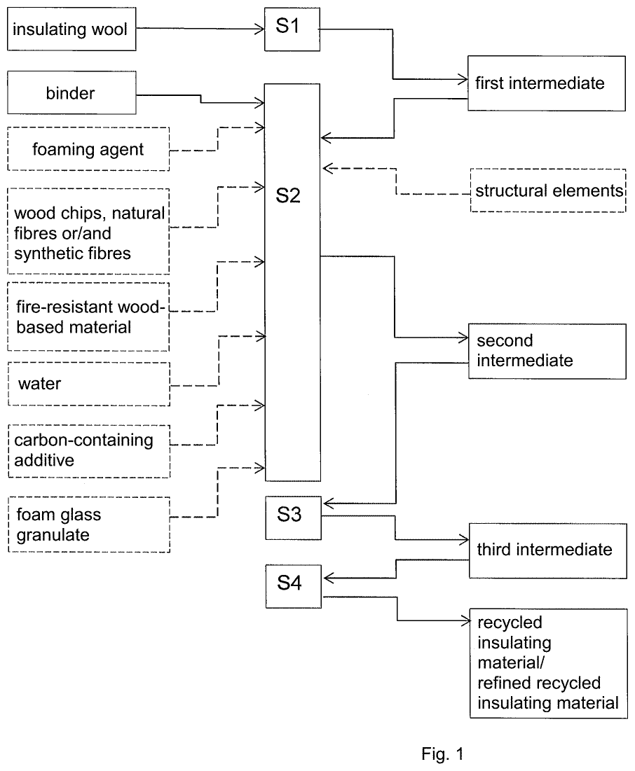

FIG. 1 is a flowchart of a method for producing a recycled insulating material;

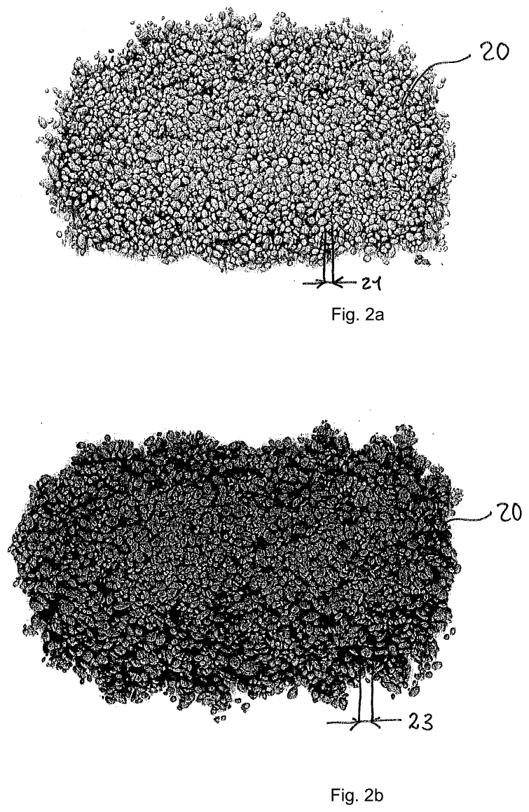

FIG. 2 is a top view of a collection of fibre balls made of comminuted glass wool

(FIG. 2a) and comminuted rock wool (FIG. 2b);

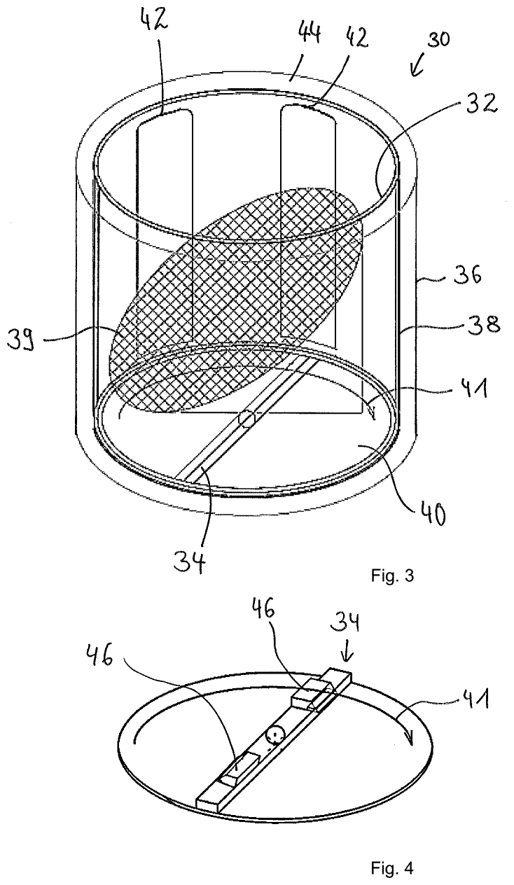

FIG. 3 is a schematic representation of an apparatus for processing insulating materials;

FIG. 4 shows a tool group which can be used in the apparatus shown in FIG. 3,

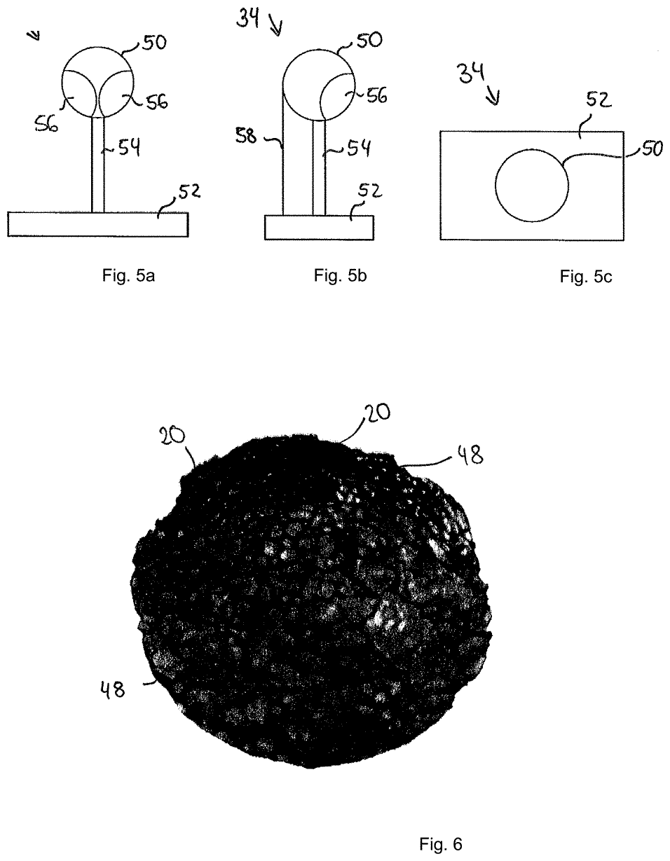

FIG. 5 shows a tool group comprising a beater, which can be used in the apparatus shown in FIG. 3,

FIG. 6 is a cross-section through a fibre-reinforced foam.

FIG. 1 is a flow chart of a method for producing a recycled insulating material from insulating wool, which comprises steps S1 to S4 according to the invention. The method steps and products outlined in FIG. 1 with solid lines are those which are required for the method for producing a recycled insulating material from insulating wool, whereas the products outlined with dashed lines are optional.

According to the invention, the insulating wool is comminuted in step S1 in order to obtain a first intermediate which comprises fibre balls 20.

Examples of fibre balls 20 made of rock wool or glass wool can be seen in FIGS. 2a and 2b. The fibre balls shown have a maximum extent of 0.1 cm to 1 cm. A fibre ball made of glass wool with a maximum extent of 2 mm is shown by way of example with the reference numeral 21, and a fibre ball made of rock wool with a maximum length of 5 mm is shown by way of example with the reference numeral 23.

A binder is added to the first intermediate in step S2 to give a second intermediate. Furthermore, in step S2 additives can be added, such as a foaming agent, wood chips, natural fibres and/or synthetic fibres, water, carbon-containing additives, lime, preferably slaked lime, or foam glass granulate. On the one hand, the binder and optionally one or more additives can be added by heaping up the first intermediate in a desired form and then pouring the binder and optionally one or more additives onto it/wetting it. On the other hand, the first intermediate, the binder and optionally one or more additives can be mixed and then formed into the desired shape.

In the subsequent step S3, the second intermediate is hot-pressed into the desired shape in order to obtain a third intermediate, which is then cured in step S4 to form the recycled insulating material. In the simplest case, the curing can be cooling and/or drying. After cooling and/or drying, the recycled insulating material can already be marketed.

However, in order to obtain a recycled insulating material with high fire resistance, a curing step can be chosen which additionally or alternatively comprises a pyrolysis treatment. Furthermore, the moisture and the mould/fungus resistance of the refined recycled insulating material is increased, and it can thus be ensured that the organic material necessary for the fungus or mould infestation is no longer present in the refined recycled insulating material.

A possible method for producing a fibre-based recycled insulating material according to an embodiment of the invention is to be described in more detail below. As a starting material, insulating wool in the form of rock wool can be comminuted in order to obtain 65% to 90% fibre balls and 10% to 35% dust and particles as the first intermediate in step S1. In step S2, water glass, for example low-sodium water glass, and possibly water glass hardener can then be added as a binder to the first intermediate in order to obtain a second intermediate, wherein the binder can be added according to one of the two options mentioned above. On the one hand, the binder and optionally one or more additives can be added by heaping up the first intermediate in a desired form and then pouring the binder and optionally one or more additives onto it/wetting it; on the other hand, the first intermediate, the binder and optionally one or more additives can be mixed and then formed into the desired shape.

As mentioned, an additive can be added in addition to the binder in step S2. The addition can take place together with the binder according to the two previously mentioned options. A conceivable additive is an inorganic additive, such as foam glass granulate, by means of which the thermal insulation and the pressure stability of the recycled insulating material can be increased.

The second intermediate can then be hot-pressed in step S3 at a temperature of 50° C. to 180° C. and a pressure of 0.05 bar to 5 bar (0.05 kg/cm² to 5 kg/cm²) in order to obtain the third intermediate. Preferably, the temperature in step S3 is between 80° C. and 180° C. in order to increase the water resistance of the material and to reduce the cycle time of the process. In this way, for example, a recycled insulating material in the form of a panel having a thickness ranging from 2 mm to 15 mm or more can be obtained.

After step S4, in which the third intermediate can be cured by means of cooling, a weather-resistant recycled insulating material can be produced which is suitable for external use.

Instead of cooling and/or drying, the curing can additionally take place by means of a pyrolysis treatment, wherein the recycled insulating material cured by means of pyrolysis treatment is also designated as refined recycled insulating material. The refinement can lead to a very high-quality mineral fibre-based recycled insulating material, which has very good fire resistance, F30, F60 (fire resistance classes according to DIN 4102-2), and can be used, for example, to insulate windows, doors or walls. In this way, a recycled insulating material in the form of a panel having a thickness ranging from 2 mm to 15 mm or more can be obtained.

An alternative method for producing a fibre-based recycled insulating material according to a further embodiment of the invention is to be described in more detail below. For this, glass wool can be used as the starting material for the insulating wool to be comminuted in step S1. The first intermediate may comprise 65% to 90% fibre balls and 10% to 35% dust and particles obtained from the comminution of insulating wool. The binder to be added in step S2 can be an organic one, such as an organic powder, an organic resin, or a renewable resource such as starch, lignin, or sugars such as dextrose, maltose, glucose, etc.

Possible binders can be in the form of powdered substances and can be mixed with the first intermediate, causing them to adhere to the fibres. Alternatively, the binders can also be used as liquid solutions. As described above, the binder can be added to the first intermediate in two different ways. On the one hand, the binder and optionally one or more additives can be added by heaping up the first intermediate in a desired form and then pouring the binder and optionally one or more additives onto it/wetting it. On the other hand, the first intermediate, the binder and optionally one or more additives can be mixed and then formed into the desired shape.

Furthermore, this first intermediate can be mixed with additional additives, such as a carbon-containing additive, a renewable raw material such as starch, lignin, sugar, if these are not already present in the binder. Additives containing carbon can also be fillers and extenders, such as sawdust, straw or other inexpensive, renewable or synthetic raw materials.

The second intermediate comprising the binder and optionally the one or more additives can then be hot-pressed to form a third intermediate in step S3 and then cooled in step S4 to form the recycled insulating material. The recycled insulating material obtained in this way can already be used as insulation if no increased fire resistance is required.

In addition, it is possible to further refine the recycled insulating material by coking it with the exclusion of oxygen. This can take place in a furnace at temperatures between 600° C. and 900° C. The carbon can fuse with the fibres and form a fibre-reinforced carbon foam. If a foaming agent, for example aluminium powder, was also added in step S2 so that it is included in the second intermediate, the gas bubbles filled with hydrogen gas that are formed as a result promote a foam structure, resulting in a closed-cell carbon foam, wherein the hydrogen gas diffuses out of the interior of the carbon foam within a very short time.

An overview of a combination of insulating wool, which is comminuted in step S1, according to its type, the selected binder, the consistency of the second intermediate and possible parameters of the method, is set out in the following table. Furthermore, the table shows a possible use of the recycled insulating material in which the curing in step S4 can only take place by means of cooling, i.e. without pyrolysis treatment, and also shows an achievable refinement by means of the pyrolysis treatment. The types of insulating wool to be comminuted that are shown in the table are type 1: production waste from the manufacture of insulating wool and/or construction site offcuts from new insulating wool; type 2: waste wool with RAL quality mark; and type 3: waste wool, harmful to health, without RAL quality mark before 1998. The abbreviation “o/a” used stands for “or/and”.

| | | | | | | | Use as insulating | |
|---|---|---|---|---|---|---|---|---|
| | | | | | | | material | |
| Insulating | Type of | | Consistency | | Pressing | | without | with |
| wool in | insulating | Type of | of second | Pressing | times in | Pressures | pyrolysis | pyrolysis |
| step 1 | wool | binder | intermediate | temperatures | minutes | in bar | treatment | treatment |
| glass wool | type 1 o/a | organic, e.g. | wet | 80° C.-160° C. | 5-120 | 0.05-2 | predominantly | partially |
| | 2 | starch | | | | | | refined |
| | | | | | | | | 20% |
| glass wool | type 1 o/a | organic, e.g. | dry or wet | 50° C.-120° C. | 5-120 | 0.05-2 | predominantly | partially |
| | 2 | lignin | | | | | | refined |
| | | | | | | | | 20% |
| glass wool | type 1 o/a | inorganic | dry or wet | 80° C.-180° C. | 20-180 | 0.1-3 | predominantly | partially |
| | 2 | e.g. water | | | | | | refined |
| | | glass | | | | | | 20% |
| | | hardener | | | | | | |
| glass wool | type 3 | inorganic, | wet | 80° C.-180° C. | 20-180 | 0.1-3 | partially | refined by |
| | | e.g. water | | | | | | pyrolysis |
| | | glass | | | | | | |
| | | hardener | | | | | | |
| glass wool | type 3 | organic, e.g. | dry or wet | 60° C.-130° C. | 10-150 | 0.1-2 | predominantly | partially |
| | | lignin | | | | | | refined |
| | | | | | | | | 20% |
| mineral | type 1 o/a | organic, e.g. | wet | 80° C.-160° C. | 5-120 | 0.05-2 | predominantly | partially |
| wool | 2 | starch | | | | | | refined |
| | | | | | | | | 20% |
| mineral | type 1 o/a | organic, e.g. | dry or wet | 50° C.-120° C. | 5-120 | 0.05-2 | predominantly | partially |
| wool | 2 | lignin | | | | | | refined |
| | | | | | | | | 20% |
| mineral | type 1 o/a | inorganic, | wet | 80° C.-180° C. | 20-180 | 0.1-3 | predominantly | partially |
| wool | 2 | e.g. water | | | | | | refined |
| | | glass | | | | | | 20% |
| | | hardener | | | | | | |
| mineral | type 3 | inorganic, | wet | 80° C.-180° C. | 20-180 | 0.1-3 | partially | refined by |
| wool | | e.g. water | | | | | | pyrolysis |
| | | glass | | | | | | |
| | | hardener | | | | | | |
| mineral | type 3 | organic, e.g. | dry or wet | 60° C.-130° C. | 10-150 | 0.1-2 | predominantly | partially |
| wool | | lignin | | | | | | refined |
| | | | | | | | | 20% |
| rock wool | type 1 o/a | inorganic, | wet | 80° C.-180° C. | 20-240 | 0.1-5 | predominantly | partially |
| | 2 | e.g. water | | | | | | refined |
| | | glass | | | | | | 20% |
| | | hardener | | | | | | |
| rock wool | type 3 | inorganic, | wet | 80° C.-180° C. | 20-240 | 0.1-5 | poss. health | refined by |
| | | e.g. water | | | | | risk | pyrolysis |
| | | glass | | | | | | |
| | | hardener | | | | | | |

A fire-resistant wood-based material, which is described below and is regarded as capable of independent protection, can also be added in step S2. The fire-resistant wood-based material comprises a wood strip which, for example, has a thickness of 1 mm to 10 mm, a width of 1 mm to 50 mm and a length of 500 mm to 4,000 mm and is optionally pricked, insulating wool fibres and a binder, which has optionally penetrated into the wood strips by means of the pricked configuration and with which the wood strips are impregnated, wherein the binder is selected from one or more of inorganic water glass, inorganic water glass specifications, organic resins such as urea, melamine or phenol, fire-retardant additives such as precipitants or acid or acid hardener. The wood strips are preferably splintered or/and preferably have an uneven surface.

The fire-resistant wood-based material is preferably made from waste wood, damaged spruce wood or poplar-like wood, with any wood being possible in principle, as well as willow or birch, for example also as damaged wood and windblown wood. Processing into wood strips can take place by means of splintering. The wood strips present as splinters can be dried and impregnated with the preferably fire-retardant binder. After the binder has dried, the wood strips can be used. Fire retardants are, for example, precipitants, acids or acid hardeners.

The addition of the fire-resistant wood-based material to a fibre pulp in step S2 is to be described below, wherein rock wool as insulating wool and an inorganic binder are preferably considered. In this way, a homogeneous and full-volume composite fibre body can be produced, without flaws or gaps or/and interstices, which comprises the fibre pulp and the fire-resistant wood-based material.

The fire-resistant wood-based material can be placed in shaped forms, for example arranged systematically in the longitudinal direction, wherein an arrangement in different orientations of the fire-resistant wood-based material is likewise possible, for example in order to increase transverse and longitudinal tensile strengths. Diagonal insertion for improved static properties is also possible.

The fire-resistant wood-based material can be laid in layers, wherein each layer can have the fibre pulp poured over it. A layer thickness can be 0.1 mm to 2 mm. A certain excess can be used here in order to close all the gaps in the wood-based material, i.e. between the wood strips. Another special feature is the shape of the press templates or press models (e.g. approx. 20 cm-60 cm wide, approx. 20 cm-60 cm high and 300 cm −1200 cm long) these are provided with outlet openings (e.g. bores (6 mm to 15 mm) so that the excess fibre-binder pulp can escape.

For example, all required layers, each with an intermediate layer of fibre pulp, can be filled into a press template of gross dimensions with a width of about 20 cm to about 60 cm, a height of about 20 cm to about 60 cm and a length of at least 300 cm to about 1200 cm. The templates can be closed and pressed under high pressure, for example 2 bar to 8 bar, i.e. 2 kg/cm² to 8 kg/cm², at a temperature of 80° to 180°. The templates may be formed such that one side and an upper ram are formed so as to be slidable. As a result, the material to be pressed can undergo a relatively linear pressure from above and from one side, which leads to an optimised and homogeneous compression in the finished material, i.e. the recycled insulating material. Hardening can take place by cooling.

With a combination of high pressure, which partially compensates for unevenness in the wood splinters, a temperature that hardens the binder, and the very stable fibre-reinforced glue joint, a recycled wood-based insulating material which can be classified in fire resistance class of at least B1, possibly A2, (according to EN 13501-1 and DIN 4102-1) can be achieved.

The fibre pulp may be advantageous for the process of making the recycled insulating material. All gaps and cavities can be filled, so that a capillary action in the material can be avoided. The fibre pulp can cure completely and can fill all cavities. Excesses can escape through the pressure valves built into the press template. The hardened fibre pulp can replace a conventional glue joint. However, because of its internal stability due to fibres, it can be significantly thicker than traditional glue joints without losing cohesion or load-bearing capacity. In the finished surface design, a new and visually very attractive image of a recycled wood-based insulating wool material can be created. This can be classified in the fire resistance class B1, if applicable A2, (according to EN 13501-1 and DIN 4102-1).

FIG. 3 is a schematic representation of an apparatus for processing insulating materials, such as mineral insulating wool. The apparatus, generally designated by 30, comprises a drum 32, a tool group 34 which is arranged on a lower region of the drum 32, a drive (not shown) which drives the drum 32 and the tool group 34 in rotation relative to one another, a housing 36 enclosing the drum 32, a suction device, not shown, and an actuating element 38. In the illustrated embodiment, the tool group 34 is mounted on a disc 40 and the disc 40 rotates relative to the drum as indicated by the arrow 41. Alternatively, it is possible for the drum 32 to be driven by the drive and for the tool group 34 to be stationary.

Due to a relative movement of the drum 32 and the tool group 34, material such as insulating wool located in the drum 32 can follow a defined material flow 39 which can run centrally in the drum 32. In this way, the material located in the drum is guided to an inner drum wall of the drum 32 and the tool group 34. This can be achieved even more advantageously if the material flow 39 is an elliptical material flow 39.

An outer wall of the drum 32 can have an opening 42 which in the present case is indicated only schematically in the lateral surface of the drum 32. The opening 42 is designed so that material located in the drum 32 can move through it in order to be able to enter an intermediate space 44 between an outer face of the drum 32 and an inner face of the housing 36. For example, three opening states of the opening 42 can be present, which can correspond to the three fractions that arise during comminution of insulating wool. For example, a first opening area can be in the form of a screen through which only dust and particles can pass, a second opening area can have first apertures that are larger than the perforations of the screen in order to allow individual fibres and small fibre bundles to pass through, and a third opening area can have second apertures which are larger than the first apertures, so that fibre balls can pass through. In addition, there can be an opening area that is so large that uncomminuted insulating wool can be introduced.

For example, the actuating element 38 can be used to vary the opening area of the opening 42 so that there are at least two different opening areas depending on the position of the actuating element. In the embodiment shown in FIG. 3, the actuating element 38 is a cylinder 38 that fits closely against the outer face of the drum 32 and has various perforations, such as slots, grids, oblong holes, which can be used as screens and first and second apertures. Depending on the positioning of the close-fitting cylinder 38 relative to the opening 42 of the drum 32, the opening 42 may correspond to one of the perforations in the close-fitting cylinder 38.

It will be understood that the drum 32 has a plurality of openings 42 and the close-fitting cylinder 38 has a corresponding number of perforations. A sheet metal material is, for example, a possible material for the production of the close-fitting cylinder 38 since it can be easily adapted to the shape of the drum 32.

Conversely, the drum 32 can also have openings with various perforations, such as slots, grids, oblong holes, which can serve as a screen and first and second apertures, and these can be opened or closed by the actuating element 38 as required.

Material exiting the drum through the openings 42 can enter the intermediate space 44. For example, a distance between the outer face of the drum and the inner face of the housing is between 50 mm and 100 mm. Thus, sufficient material can accumulate in the intermediate space 44 and can be removed from there by means of the suction device, not shown. A filter, a screen and/or an air classifier can be connected to the suction device in order to be able to better fractionate the material into the appropriate fractions for further processing.

A possible tool group 34, such as can be used in the apparatus 30 shown in FIG. 3, is shown in FIG. 4. This preferably comprises two cutting tools 46, the cutting edges of which are aligned in the direction of rotation. In FIG. 4 the tool group 34 is arranged, for example, on a disc 40 which can rotate relative to the drum 32, as indicated by the arrow 41.

Another possible tool group 34, such as can be used in the apparatus 30 shown in FIG. 3, is shown in FIGS. 5a, 5b and 5c in a front view, side view and top view, respectively. This can comprise at least one spherical beater 50, a base 52 and a shaft 54 connecting the spherical beater 50 and the base 52. The spherical beater 50 may have apertures 56 which may be formed in a hemispherical shape as shown in FIGS. 5a and 5b or in another shape such as a pyramid shape. The spherical beater 50 can have a diameter of about 30 mm, for example from 25 mm to 35 mm, in order to ensure effective processing of insulating wool. The shaft 54 can have a length of 50 mm to 150 mm, wherein the length is determined in such a way that, on the one hand, material accumulation is avoided and, on the other hand, a stable attachment can be achieved. In order to increase the stability of the shaft 50, a reinforcement 58 which is, for example, welded on can also be provided, as can be seen in FIG. 5b. It goes without saying that this group of tools can be arranged on the disk 40 of the apparatus 30.

An example of a fibre-reinforced foam is shown in FIG. 6. The fibre balls 20, which are covered by the fibre-reinforced foam, are visible in this figure. The illustrated fibre-reinforced foam has an approximately circular shape in cross section, but may have any other shape in cross section, such as rectangular or triangular. It can also be seen in FIG. 6 that between the fibre balls 20 the fibre-reinforced foam has intermediate regions 48 which are cavities 48, for example.

The apparatus can also have nozzles which are set up to spray a liquid, for example a binder or an additive, onto a material located in the drum, for example onto insulating wool which has been comminuted or is to be comminuted.

The system can be encapsulated when the apparatus is used for insulating wool of type 3, i.e. with waste wool that is hazardous to health without the RAL quality mark.

1. Method for producing a recycled insulating material from insulating wool, comprising the steps of:
S1: comminuting insulating wool to give a first intermediate comprising fibre balls;
S2: adding binder to the first intermediate to give a second intermediate;
S3: hot-pressing the second intermediate into the desired shape to obtain a third intermediate; and
S4: curing the third intermediate to obtain the recycled insulating material.

2. Method for producing a recycled insulating material from insulating wool according to claim 1, wherein
the insulating wool to be comminuted is rock wool and the binder is inorganic and comprising water glass, or
the insulating wool to be comminuted is glass wool and the binder is organic and comprising one or more of powder, urea, resins, starch, lignin and sugars.

3. Method for producing a recycled insulating material from insulating wool according to claim 1, wherein a foaming agent is also added in step S2.

4. Method for producing a recycled insulating material from insulating wool according to claim 1, wherein wood chips are also added in the step S2.

5. Method for producing a recycled insulating material from insulating wool according to claim 1, wherein in step S3 the second intermediate is hot-pressed at a temperature of 50° C. to 180° C. and a pressure of 0.05 bar to 5.0 bar.

6. Method for producing a recycled insulating material from insulating wool according to claim 1, wherein in step S4 the curing comprises a pyrolysis treatment of the third intermediate to form the recycled insulating material.

7. Method for producing a recycled insulating material from insulating wool according to claim 6, wherein the pyrolysis treatment takes place with the exclusion of oxygen at temperatures between 400° C. and 1450° C.

8. Method for producing a recycled insulating material from insulating wool according to claim 6, wherein the pyrolysis treatment is a sintering process which takes place at temperatures between 1200° C. and 1450° C.

9. Method for producing a recycled insulating material from insulating wool according to claim 6, wherein before the pyrolysis treatment the third intermediate is provided with channels which at least partially extend into an interior of the third intermediate, or is provided with depression profiles which extend on a surface.

10. Method for recycling insulating wool, comprising a method according to claim 1, wherein in step S1 fibres are also obtained and wherein the fibres are processed in a method for producing insulating wool.

11. Apparatus for processing insulating wool, comprising:
a drum;
a tool group which is arranged on a lower region of the drum;
a drive which drives the drum and the tool group to rotate relative to one another;
a housing enclosing the drum;
a suction devices; and
an actuating element,
wherein:
at least one outer wall of the drum has an opening, so that an intermediate space between an outer face of the drum and an inner face of the housing is connected via the opening to an interior of the drum;
a position of the actuating element determines how much material can pass through the opening; and
the suction device is set up to draw off material located in the intermediate space.

12. Apparatus for processing insulating wool according to claim 11, wherein the tool group comprises at least one tool selected from a rake, a rod, a cutting tool, a friction body, a trapezoid, a comb, a beater or a combination thereof.

13. Apparatus for processing insulating wool according to claim 11, wherein the apparatus also comprises an inner drum wall tool group which is arranged on or adjacent to an inner drum wall of the drum.

14. Apparatus for processing insulating wool according to claim 13, wherein the opening is arranged on a lateral surface of the drum, on the outer face or inner side of which the actuating element is arranged such that the opening area of the opening through which material can pass is determined by means of the positioning of the actuating element.

15. Fibre-reinforced foam comprising a foam and fibres which are embedded in the foam.

16. Fire-resistant wood-based material, comprising:
a wood strip,
insulating wool fibres; and
binder with which the wood strip is impregnated,
wherein the binder is selected from one or more of inorganic water glass, inorganic water glass specifications, organic resins such as urea, melamine or phenol, and fire-retardant additives such as precipitants or acid or acid hardeners.

17. Fire-resistant wood-based material according to claim 16, wherein a plurality of wood strips with the fibres and the binder are pressed or/and glued together to form a profile.

18. Method for producing a fire-resistant wood-based material, comprising the steps of
providing a wood strip;
adding insulating wool fibres; and
impregnating the wood strip with liquid binder which is selected from one or more of inorganic water glass, inorganic water glass specifications, organic resins such as urea, melamine or phenol, and fire-retardant additives such as precipitants or acid or acid hardener.

19. Method for producing a fire-resistant wood-based material according to claim 18, wherein the method further comprises:
providing a plurality of wood strips produced according to claim 18;
applying adhesive to the plurality of wood strips; and
pressing the plurality of wood strips and the insulating wool fibres together.

20. Fire-resistant wood-based material according to claim 16, wherein the wood strips are made of waste wood, spruce wood, preferably spruce wood damaged by bark beetles, or/and poplar-like wood or/and birch wood or/and willow wood.
